(19) United States
(12) Patent Application Publication
(10) Pub. No.: US 2005/0120749 A1
(43) Pub. Date: Jun. 9, 2005

(54) System and process for controllable preparation of glass-coated microwires

(76) Inventors: Eliezer Adar, Varburg (IL); Ebud Yaffe, Yifat (IL)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/496,781

(22) PCT Filed: Jan. 7, 2003
(86) PCT No.: PCT/IL04/00009

(30) Foreign Application Priority Data
Jan. 9, 2003 (IL) 153861

(51) Int. Cl. C03C 27/02

(52) U.S. Cl. 65/59.6; 65/442

(57) ABSTRACT

A process and system for controllable production of continuous lengths of microwire having a core covered by a glass coating are provided. According to the method of the invention, a glass tubing is loaded with a core material. Thereafter, the process includes the step of heating the tubing containing the core material for melting thereof, softening a tip of the glass tubing and forming a drop of the core material in the molten state surrounded by an outer glass shell. During the process, the gas is evacuated from the glass tubing in order to control elevation of the drop. The method includes drawing the heated outer glass shell into a continuous microwire filament and stabilizing the temperature and mass of the drop during the process. Accordingly, the system includes a suitable glass feeder mechanism, a rod feeder mechanism, a furnace configured for forming a drop of the core material in the molten state surrounded by an outer glass shell, controllable vacuum and cooling devices and a receiver section for receiving the microwire obtained after the cooling. The system also includes a controller and sensing means configured for producing signals representative of the gas pressure in the tubing, temperature temperature of the drop, the speed of the microwire, the value of the microwire diameter, the value of the spool diameter and other relevant parameters.

### FIELD OF THE INVENTION

This invention relates to the preparation of small diameter wires, and in particular, for controlling the preparation of glass-coated microwires.

### BACKGROUND OF THE INVENTION

It has been the tendency in modern miniaturization technologies to demand new materials and process for their production from material engineering. The development of thin film technologies followed by the revolution in telecommunications and computers, is a good example of the application of this engineering. Various technical solutions in miniaturization technologies also require fine microwires.

The method for the preparation of microwires covered with glass referred to as the Taylor method was proposed many years ago (see an article by G. F. Taylor in “Physical Review” 23, 655 (1924) and U.S. Pat. No. 1,793,529 to Taylor). This method was developed later in various prior art publications (see, for example, U.S. Pat. No. 3,214,805 to McKenica; U.S. Pat. No. 3,256,584 to Parkhachev; U.S. Pat. No. 3,362,803 to Dannönhl et al.; U.S. Pat. No. 3,481,390 to Veltri et al.; U.S. Pat. No. 3,483,072 to Cox et al; U.S. Pat. No. 3,607,201 to Zaborovsky et al.; U.S. Pat. No. 3,791,172 to Manfre et al.; U.S. Pat. No. 5,110,334 to Ayers; and U.S. Pat. No. 5,240,066 to Gorynin et al.).

According to these techniques, a glass tubing containing the desired metal batch is heated to a temperature sufficient to melt the metal and soften the glass. In general, the heating is obtained via electromagnetic induction for melting the metal which, in turn, softens the glass. The outer glass shell is then drawn out as fine as desired. As a result, two coaxial flows arise: one of the melted metal in the center and another of softened glass around the metal one. After leaving the heating zone, both flows pass through a water stream, for cooling and solidifying. The result is a continuous microwire with the metal being continuously cast as a core covered with a glass coating. The velocity at which the microwire is wound on a bobbin is usually from a few meters up to some hundreds of meters per minute. Although the preparation process seems to be simple, it is a multi-parameter process, which requires sophisticated process control and special methods for the preliminary treatment of the metal and glass raw materials.

U.S. Pat. No. 3,607,201 describes a system for casting a microwire in glass insulation, including a device for effecting the inspection of the quality of the microwire and automatic correction of the processes of casting the microwire. The quality of the microwire is characterized by the resistance of the microwire per running meter in the process of its casting. The automatic maintaining of the value of the linear resistance of the microwire within the range of the specified value is achieved by correcting the temperature and volume of the metal batch and correcting the speed of reception of the microwire by the receiving bobbin.

A method for preparing glass-coated microwires is provided in U.S. Pat. No. 5,240,066, wherein the rate of cooling is controlled such that an amorphous or microcrystalline structure is obtained for the metal. The amorphous or microcrystalline structure can also be controlled by the choice of amorphisizers, nature of the cooling liquid, location of the cooling stream, dwell time in the cooling stream and degree of superheating and supercooling.

One of the disadvantages of the existing techniques for production of the glass-coated microwires is the absence of effective means for the process control, ensuring the reproducibility of the casting process and the production of the microwire having the specified properties. Additionally, it is difficult, and in some instances even impossible, to obtain continuous coated microwires of uniform diameter using the conventional techniques.

### GENERAL DESCRIPTION OF THE INVENTION

Thus, despite the extensive prior art in the area of glass-covered microwires, there is still a need for further improvements for controlling the production of the glass-coated microwires. It is desirable that the production process be automatic and controlled with online recording of the actual diameter of the microwire. It is desirable that the production process would be very stable so the apparatus for production of the glass-coated microwires could run continuously for several hours.

The present invention satisfies the aforementioned need by providing a novel system for the controllable production of continuous lengths of a microwire having a core covered by a glass coating. The system includes a suitable glass feeder mechanism for providing the supply of a glass tubing and a rod feeder mechanism for providing the supply of a rod or bar made of a core material. The glass feeder mechanism is controllable by a glass feeder signal and includes a driving motor which acts on the glass tubing for providing a supply of a glass material with a required speed. By the same token, the rod feeder mechanism is controllable by a rod feeder signal and includes a driving motor which acts on the rod for providing the supply of a core material with a required speed. The glass and rod feeder signals are generated by a controller configured to control the system.

A tip of the glass tubing loaded with the rod is introduced into a furnace adapted for softening the glass material making up the tubing and melting the rod, such that a drop of the wire material in the molten state is formed. According to one embodiment of the invention, the furnace includes at least one high frequency induction coil, e.g. one wind coil.

The temperature of the drop is measured by a temperature sensor that is operable for producing a temperature sensor signal. The temperature sensor is coupled to the controller which is, inter alia, responsive to the temperature sensor signal and capable of providing by means of a PID (proportional, integral, derivative) loop a control for regulating the temperature of the drop for stabilizing and maintaining it at a required magnitude.

One way of regulating the drop temperature is the regulation of the temperature of the furnace by changing the furnace's power consumption. For this purpose, the controller is capable of generating a power signal, by means of a PID control loop, to a power supply unit of the furnace.

Because, the furnace includes a high frequency induction coil, the increase in the consumption power leads to the elevation of the drop, due to the levitation effect. Hence, the temperature of the drop depends on many parameters and does not always change in the desired direction when only the consumption power is regulated.

According to one embodiment of the invention, the compensation of the levitation effect is accomplished by the regulation of the gas pressure in the tubing. Thus, in order to avoid the droplet elevation due to the increase of the consumption power, the negative gas pressure (with respect to the atmospheric pressure) is decreased to a required value calculated by the controller.

For this purpose, the system is further provided with a vacuum device capable of evacuating gas from the tubing. The vacuum device is coupled to the tubing via a suitable sealable coupling element so as to apply negative gas pressure to the inside volume of the tube while allowing passage of the rod therethrough. The vacuum device is controllable by a vacuum device signal generated by the controller module for providing variable negative pressure (with respect to the atmospheric pressure) to the molten metal drop in the region of contact with the glass. The pressure variation permits the manipulation and control of the molten metal in the interface with the glass in a manner as may be suitable to provide a desirable result.

According to one embodiment of the invention, the vacuum device includes first and second vessels containing a gas and pump configured for transferring the gas from said first vessel to said second vessel through a pipeline, thereby maintaining negative gas pressure in said second vessel. The first vessel is configured for communicating with said second vessel through a first valve and with the glass tubing through a second valve. The first and second valves are controllable by the controller for providing variable negative gas pressure to the tubing, while maintaining the total gas flow to be constant.

A pressure sensor producing a pressure sensor signal representative of gas pressure in the tubing is arranged between the tubing and the vacuum device. The controller is responsive to the pressure sensor signal as well as to the power consumption sensor signal and temperature sensor signal. On the basis of these signals, the controller is able to provide a PID control and is configured to regulate the negative gas pressure in the tubing by generating the aforementioned vacuum device signal.

According to another embodiment of the invention, the vacuum device includes a pressure sensor producing a pressure sensor signal representative of gas pressure in the tubing and arranged within a pipeline connected to the tubing. The vacuum device further includes a closed-loop pipeline coupled to the tubing in a T-type manner through a valve. The vacuum device yet includes a fan arranged within the closed-loop pipeline and arranged for circulating the gas inside the closed-loop pipeline. The operation of the vacuum device according to this embodiment of the invention is based on the Venturi suction effect.

According to one example, the vacuum device signal generated by the controller module is fed to the valve for providing variable negative gas pressure in the tubing. According to another example, the vacuum device signal generated by the controller module is fed to the fan for regulating the speed of the gas circulating in the closed-loop pipeline for effecting the Venturi action.

According to still another embodiment of the invention, the vacuum device includes an open pipeline coupled to the glass tubing a T-type manner through a valve. A fan is arranged within the open pipeline for venting the atmospheric air therethrough. As well as in the previous embodiment, the vacuum device can be controlled by the vacuum device signal generated by the controller module that can be fed to either the valve or to the fan for effecting the Venturi action.

According to still another embodiment of the invention, the fan in the previous embodiments can be replaced with a pump controlled by the controller.

The system is further provided with a cooling device, arranged downstream of the furnace and adapted for cooling a microwire filament drawn out from the drop. The cooling device is built in such a way that the filament being formed passes though a cooling liquid where it supercools and solidifies, and thereafter proceeds as a microwire towards a receiver section arranged downstream of the cooling device.

The receiver section comprises a spooler for collecting the finished microwire product. The spooler includes at least one receiving spool, a spool diameter sensor, a drive motor assembly and a guide pulley assembly. The spool diameter sensor is configured for measuring an effective core diameter of the spool and generating a spool diameter sensor signal. The drive motor assembly is controllable by a spool speed signal generated by the controller module for rotating the spool with a required cyclic speed in response to the spool diameter sensor signal. The cyclic speed is regulated in order to maintain the linear speed of the microwire at the desired value.

The receiver section can further include a tension unit having a tension sensor configured for generating a tension sensor signal. The tension unit includes a tension generator controllable by a wire tension signal produced by the controller module in response to the tension sensor signal. The tension generator is arranged to create tension of the microwire.

The receiver section can also include a wax applicator for waxing the microwire. The system can also include a micrometer arranged downstream of the tension unit and configured for measuring the microwire overall diameter, length and other parameters, e.g., a microwire speed.

The mass of the drop is a crucial parameter in the mass production of microwires. The thickness of the microwire metal core is not stable and the glass layer in the microwire decreases when the mass of the drop decreases, due to the decrease in the metal/glass interface area. According to one embodiment of the invention, the mass of the drop is controlled in order to keep the mass stable. For this purpose, the rod feeder mechanism, controllable by the controller, is configured to supply the rod at the required speed.

Thus, according to one broad aspect of the present invention, there is provided a system for the controllable production of continuous lengths of a microwire having a core covered by a glass coating, comprising:
(a) a glass feeder mechanism controllable by a glass feeder signal for providing a supply of a glass tubing;
(b) a rod feeder mechanism controllable by a rod feeder signal for providing a supply of a rod made of a core material;
(c) a furnace configured for forming a drop of the core material in the molten state surrounded by an outer glass shell;
(d) a vacuum device controllable by a vacuum device signal for providing variable negative pressure in the tubing to the molten drop in the region of contact with the glass;
(e) a cooling device downstream of the furnace adapted for cooling the microwire drawn out from the drop;
(f) a receiver section downstream of said cooling device including:
   a spooler having at least one receiving spool and a drive motor assembly controllable by a spool speed signal, the spooler being adapted for receiving the microwire obtained after the cooling;
(g) sensing means configured for producing at least one sensor signal from the list including:
   a pressure sensor signal representative of the gas pressure in the tubing,
   a temperature sensor signal representative of the temperature of the drop,
   a wire speed sensor signal representative of the speed of the microwire,
   a diameter sensor signal representative of the value of the microwire diameter,
   a spool diameter sensor signal representative of the value of the spool diameter;
(h) a controller operatively coupled to said glass feeder mechanism, said rod feeder mechanism, said furnace, said controllable receiver unit and said sensing means,
   said controller being responsive to said at least one sensor signal and configured for controlling the operation of the system by generating at least one signal selected from the list including: said glass feeder signal, said rod feeder signal, said furnace power signal, the vacuum device signal, the spool speed signal and a wire tension signal.

According to another broad aspect of the present invention, there is provided a process for the controllable production of continuous lengths of microwire having a core covered by a glass coating, comprising:
(a) providing a glass tubing;
(b) loading the glass tubing with a core material;
(c) heating the tubing containing the core material, thereby melting said core material, softening a tip of said glass tubing and forming a drop of the core material in the molten state surrounded by an outer glass shell;
(d) evacuating gas from said glass tubing to control elevation of the drop;
(e) drawing the heated outer glass shell into a continuous microwire filament; and
(f) stabilizing temperature and mass of the drop during the process.

According to one embodiment of the invention, the stabilizing of the temperature and mass of the drop is performed by controlling the negative gas pressure in the tubing and electric power consumption. According to this embodiment of the invention, the controlling of the negative gas pressure in the tubing and the electric power consumption is performed by adjusting the speed of supply of the core material. Adjusting the speed of supply of the core material is performed until the negative gas pressure in the tubing and electric power consumption are stabilized to substantially constant magnitudes.

According to another embodiment of the invention, stabilizing the temperature and mass of the drop is performed by adjusting the speed of said continuous microwire filament.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic illustration of the system for mass manufacture of continuous lengths of glass coated microwire, according to one embodiment of the invention;

FIG. 2 is a schematic illustration of the vacuum device, according to one embodiment of the invention;

FIG. 3 is an example of regulation of the process parameters during the production of the microwire made according to the invention;

FIG. 4 is another example of regulation of the process parameters during the production of the microwire made according to the invention; and

FIG. 5A and FIG. 5B is a schematic illustrated of the vacuum device, according to another two embodiments of the invention.

### DETAILED DESCRIPTION OF THE INVENTION

The principles and operation of the process and apparatus according to the present invention may be better understood with reference to the drawings and the accompanying description, wherein like reference numerals have been used throughout to designate identical elements. It is understood that these drawings are given for illustrative purposes only and are not meant to be limiting.

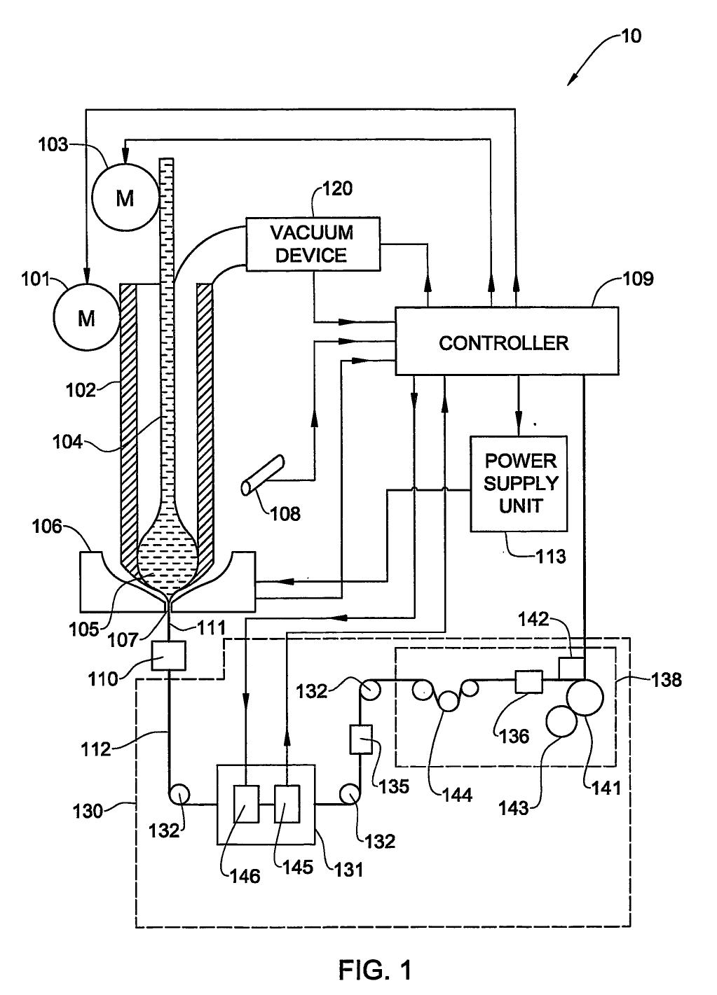

Referring initially to FIG. 1, a system for a mass manufacture of continuous lengths of glass coated microwire is shown in schematic form in order to illustrate the process according to one embodiment of the invention. It should be noted that the blocks in FIG. 1 are intended as functional entities only, such that the functional relationships between the entities are shown, rather than any physical connections and/or physical relationships. The system of FIG. 1, generally identified by reference numeral 10, includes a suitable glass feeder mechanism diagrammatically represented by a circle 101 for providing a supply of a glass tubing 102. The system also includes a rod feeder mechanism diagrammatically represented by a circle 103 for providing a supply of a rod, bar or wire 104 made of a core material. It should be appreciated that the mechanisms 101 and 103 can be both configured in one feeder device that may serve a multiple function for providing a supply of glass and core materials. The glass feeder mechanism 101 is controllable by a glass feeder signal and includes a driving motor (not shown) which acts on the glass tubing 102 for providing a supply of a glass material with a required speed. By the same token, the rod feeder mechanism 103 is controllable by a rod feeder signal and includes a driving motor (not shown) which acts on the rod 104 for providing a supply of a core material with a required speed. The glass and rod feeder signals are generated by a controller 109 configured to control the system 10.

The rod 104 can be of any metal, elemental semiconductor (such as Si and Ge), non-ceramic semiconducting compound or metallic based superconductors which has a melting temperature below the working temperature of the glass. It is noted that the expression “working temperature” hereinafter is to be understood to mean the temperature at which the viscosity of the glass is less than 10⁴ poise. Examples of the metals to be used according to the present invention include, but are not limited to, copper, gold, silver, platinum, rhodium, iron, nickel, or alloys based on these metals. Various different semiconductors may be used according to the present invention. The non-ceramic semiconducting compounds include, but are not limited to, GaSb and InSb.

A diameter of the rod 104 can, for example, be between 2 mm and 7 mm for low heat conductive materials and between 0.1 and 4 mm for high heat conductive materials.

Examples of the glasses of the glass tubing 102 include, but are not limited to, quartz glasses, silica glasses, alkali silicate glasses, soda-lime glasses, borosilicate glasses, aluminosilicate glasses, and lead glasses. One exemplary glass which may be used in accordance with the present invention is designated under glass code borosilicate 3.3, available from Schott, Germany, and contains (by weight) 81% SiO₂, 2% Al₂O₃, 13% B₂O₃, 4% (Na₂O+K₂O). Another typical glass is designated glass code AR-Glas (Soda Glass), also available from Schott, Germany, containing (by weight) 69% SiO₂, 1% B₂O₃, 3% K₂O, 3% Al₂O₃, 13% Na₂O, 2% BaO, 5% CaO, 3% MgO. It should be understood that various alternative glasses may be selected by one skilled in the art for the particular desired application and environment in which the coated wire composite is to be used. Pyrex glass, Soda glass and Quartz glass are the most common.

A diameter of the glass tubing 102 can, for example, be between 8 mm and 30 mm.

A tip of the glass tubing 102 loaded with the rod 104 is introduced into a furnace 106 adapted for softening the glass material making up the tubing 102 and melting the rod 104 in the vicinity of the exit orifice 107, such that a drop 105 of the wire material in the molten state is formed.

According to one embodiment of the invention, the furnace 106 includes at least one high frequency induction coil, e.g. one wind coil. The operation of the furnace 106 is known per se, and will not be expounded in details below.

An exemplary furnace that has been shown to be suitable for the manufacturing process of the present invention is the Model HFP 12, manufactured by EFD Induction Gmbh, Germany.

The temperature of the drop is measured by a temperature sensor pointing at the hottest point of the drop and diagrammatically represented by a box 108. An example of the temperature sensor includes, but is not limited to, the Model Omega OS1553-A produced by Omega Engineering Ltd.

The temperature sensor 108 is operable for producing a temperature sensor signal. The temperature sensor 108 is coupled to the controller 109 which is, inter alia, responsive to the temperature sensor signal and capable of providing a control by means of a PID loop for regulating the temperature of the drop 105 for stabilizing and maintaining it at a required magnitude. For example, the temperature of the drop can be maintained in the range of 800° C. to 1500° C.

It should be appreciated that one way of regulating the drop temperature is the regulation of the temperature of the furnace 106 by changing the furnace's power consumption. For this purpose, controller 109 is capable of generating a furnace power signal, by means of a PID control loop, to a power supply unit 113 of the furnace 106. For example, when the consumption power increases, the drop temperature should also increase, provided by the condition that the position of the drop 105 does not change with respect to the furnace 106. However, since the furnace includes a high frequency induction coil, the increase of the consumption power leads to the elevation of the drop, due to the levitation effect. Hence, the temperature of the drop depends on many parameters and does not always change in the desired direction when only the consumption power is regulated.

An example of the power supply unit 113 includes, but is not limited to the Mitsubishi AC inverter, Model FR-A540-11k-EC, Mitsubishi, Japan.

According to one embodiment of the invention, the compensation of the levitation effect is accomplished by the regulation of the gas pressure in the tubing 102. Thus, in order to avoid the droplet elevation due to the increase of the consumption power, the negative gas pressure (with respect to the atmospheric pressure) is decreased to a required value calculated by the controller 109.

For this purpose, the system 10 is further provided with a vacuum device identified by reference numeral 120 for evacuating gas from the tubing 102. The vacuum device 120 is coupled to the tubing 102 via a suitable sealable coupling element (not shown) so as to apply negative gas pressure to the inside volume of the tube 102 while allowing passage of the rod 104 therethrough.

The vacuum device 120 is controllable by a vacuum device signal generated by the controller 109 for providing variable negative pressure to the molten metal drop in the region of contact with the glass. The pressure variation permits the manipulation and control of the molten metal in the interface with the glass in a manner as may be suitable to provide a desirable result. For example, the gas pressure inside the tubing 102 can be varied in the range of about 0 milibars to −20 milibars, and preferably between −2 milibars and −7 milibars.

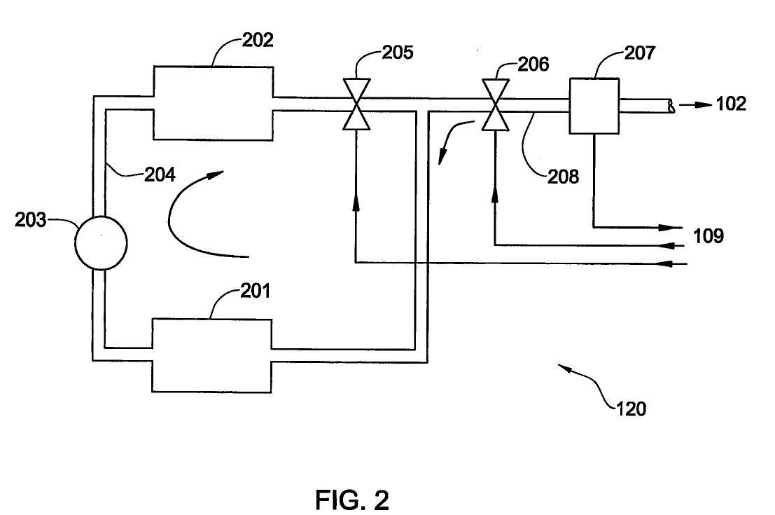

Referring to FIG. 2, a schematic view of the vacuum device 120 is illustrated, according to one embodiment of the invention. The vacuum device 120 includes a pump 203 coupled to a first vessel 201 and a second vessel 202 filled with a gas. The pump 203 transfers the gas from the first vessel 201 into the second vessel 202 through a pipeline 204 for maintaining negative gas pressure in the first vessel. The negative gas pressure can, for example, have a value in the range of about −100 milibars to −400 milibars. Examples of the gas include, but are not limited to, air, argon, nitrogen, etc., and various mixtures thereof. The first vessel 201 and second vessel 202 communicate with one another through a first valve 205 and with the tubing (102 in FIG. 1) through a second valve 206.

A first vacuum device signal and a second vacuum device signal generated by the controller 109 regulate the first valve 205 and the second valve 206 of the vacuum device 120, respectively, for providing variable negative gas pressure in the tubing 102, while maintaining the total gas flow to be constant. A pressure sensor 207 producing a pressure sensor signal representative of gas pressure in the tubing (102 in FIG. 1) is arranged within a pipeline 208 between the tubing (102 in FIG. 1) and the valve 206. The pressure sensor 207 is operatively coupled to the controller 109. The controller 109 is responsive to the pressure sensor signal as well as to the power consumption sensor signal and temperature sensor signal. On the basis of these signals, the controller 109 is able to provide a PID control and is configured to regulate the negative gas pressure in the tubing (102 in FIG. 1) by generating the aforementioned vacuum device signal.

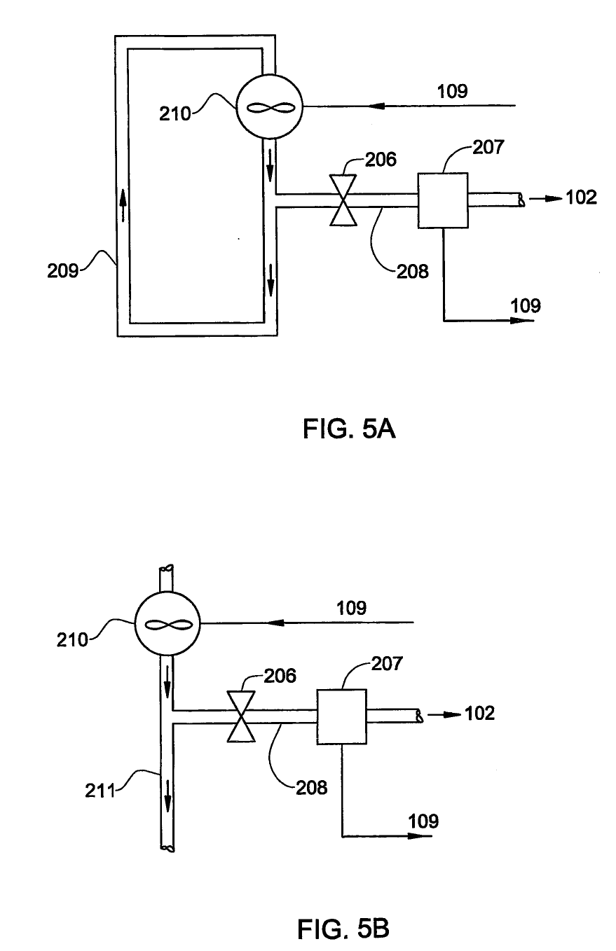

Referring to FIG. 5A, a schematic view of the vacuum device 120 is illustrated, according to another embodiment of the invention. As well as in the embodiment shown in FIG. 2, the vacuum device 120 includes the pipeline 208 connected to the tubing (102 in FIG. 1). The pressure sensor 207 producing a pressure sensor signal representative of gas pressure in the tubing (102 in FIG. 1) is arranged within the pipeline 208 between the tubing (102 in FIG. 1) and the valve 206. The vacuum device 120 further includes a closed-loop pipeline 209 connected to the pipeline 208 in a T-type manner, and a fan 210 arranged within the closed-loop pipeline 209 and arranged for circulating the gas inside the closed-loop pipeline 209. The operation of the vacuum device according to this embodiment of the invention is based on the Venturi effect that is known per se.

According to this embodiment of the invention, the vacuum device signal generated by the controller 109 is fed to the fan 210 for regulating the speed of the gas circulating in the closed-loop pipeline 209 and thereby providing a variable negative gas pressure in the tubing by effecting the Venturi action.

Referring to FIG. 5B, a schematic view of the vacuum device 120 is illustrated, according to still another embodiment of the invention. As well as in the embodiment shown in FIG. 5B, the operation of the vacuum device 120 is based on the Venturi effect. According to this embodiment, the vacuum device 120 also includes the pipeline 208, the pressure sensor 207 and the valve 206. Instead of the closed-loop pipeline (209 in FIG. 5A), according to this embodiment, the vacuum device 120 includes an open pipeline 211 connected to the pipeline 208 in a T-type manner. The vacuum device 120 also includes a fan 210 arranged within the pipeline 211 and arranged for venting the atmospheric air therethrough.

As well as in the previous embodiment, the vacuum device 120 can be controlled by the vacuum device signal generated by the controller 109 that can be fed to the fan 210 for effecting the Venturi action.

It should be understood that the described above arrangements of the vacuum device 120 represents only three of various ways in which the molten glass/metal interface may be manipulated and that various vacuum arrangements, as well as other methods, may be utilized to provide the desired manipulation and control of the molten metal/glass interface.

Turning back to FIG. 1, the system 10 is further provided with a cooling device 110, arranged downstream of the furnace 106 and adapted for cooling a microwire filament 111 drawn out from the drop 105. The microwire filament 111 can be drawn at a speed in the range of 5 m/min to 1500 m/min through the cooling device 110. The cooling device 110 is built in such a way that the filament 111 being formed passes though a cooling liquid where it supercools and solidifies, and thereafter proceeds as a microwire 112 towards a receiver section 130 arranged downstream of the cooling device 110. The rate of cooling can be regulated, for example, in the range of 10⁵° C./sec to 10⁶° C./sec for amorphous core materials.

The receiver section 130 comprises a spooler 138 for collecting the finished microwire product. The spooler 138 includes at least one receiving spool 141, a spool diameter sensor 142, a drive motor assembly 143 and a guide pulley assembly 144. The spool diameter sensor is configured for measuring an effective core diameter of the spool and generating a spool diameter sensor signal representative of the value of the spool diameter.

The drive motor assembly 143 is controllable by a spool speed signal generated by the controller 109 for rotating the spool with a required cyclic speed in response to the spool diameter sensor signal. The cyclic speed is regulated in order to maintain the linear speed of the microwire at the desired value.

An example of the spooler 138 includes, but is not limited to, the Model M/HOA-0/1-63S, produced by MAG, Austria.

The receiver section 130 can further include a tension unit 131 having a tension sensor 145 configured for generating a tension sensor signal. An example of the tension sensor includes, but is not limited to, a tension meter produced by Tensometric Messtechnik, Strohmann & Co GmbH.

The tension unit 131 includes a tension generator 146 controllable by a wire tension signal produced by the controller 109 in response to the tension sensor signal. The tension generator 146 is arranged to create tension of the microwire.

The receiver section 130 can also include a wax applicator 136 for waxing the microwire. The system 10 can also include a micrometer 135 arranged downstream of the tension unit 131 and configured for measuring the microwire overall diameter, length and other parameters, e.g., a microwire speed. The micrometer 135 is configured for producing, inter alia, a wire diameter sensor signal representative of the microwire overall diameter. The micrometer 135 is operatively coupled to the controller 109 that is responsive to the diameter sensor signal and operable for generating a corresponding signal for regulating, inter alia, the drop temperature, for stabilizing the overall microwire diameter.

According to one embodiment of the invention, the micrometer 135 is mounted in the receiver section 130. An example of the micrometer 135 includes, but is not limited to, a laser micrometer LDS150, produced by CERSA, France.

The receiver section 130 also includes a required number of guide pulleys 132 arranged for providing a required direction to the microwire.

It should be appreciated that in contrast to the conventional techniques, where the receiver unit is a receiving spool arranged under the cooling device, the receiver unit 130 of the present invention is provided with a possibility to regulate a rotating speed of the spool, in order to obtain a constant linear speed of the microwire. In the conventional techniques, the receiving spool rotates with a certain constant cyclic speed. As a result, the linear speed of the spool surface receiving the microwire increases, due to the increase of the spool diameter. Such increase is not significant when the spool has a small number of reeling layers. However, when the number of the reeling layers is relatively high, this growth of the linear speed may decrease the microwire overall diameter, and thereby deteriorate the quality of the finished microwire product.

According to the invention, the system 10 can take into account the human engineering factors. In particular, due to the fact that the receiving spool 138 is not arranged directly under the tubing 102, it can be mounted on a desired height that is convenient for the operator of the system.

It should be further appreciated that the mass of the drop (105 in FIG. 1) is also a crucial parameter in the mass production of microwires. For example, the chemical composition of the drop changes during the production process when the mass of the drop decreases. The thickness of the microwire metal core is not stable and the glass layer in the microwire decreases when the mass of the drop decreases, due to the decrease in the metal/glass interface area.

According to one embodiment of the invention, the mass of the drop is controlled in order to keep the mass stable. For this purpose, the rod feeder mechanism controllable by the controller 109 is configured to supply the rod 104 at the required speed.

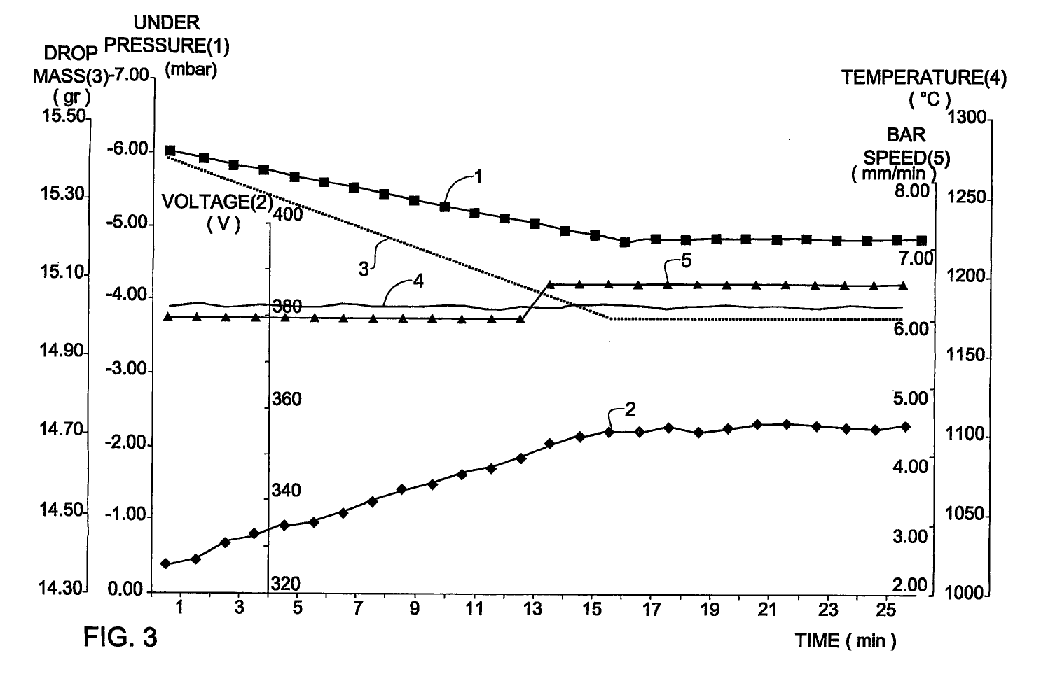

Referring to FIG. 3, an example of regulation of the process parameters during the production of the microwire made of cobalt alloy including cobalt, silicone, iron and boron is illustrated according to the invention. According to this example, the tubing 102 is provided having an inside diameter of approximately 17.6 mm and an outside diameter of approximately 20 mm. The rod 104 is provided having a diameter of approximately 5 mm, in order to provide a 0.025 mm coating layer on a 0.033 mm diameter microwire such that the coated microwire composite has a total diameter of 0.038 mm.

In particular, FIG. 3 shows time dependencies of negative gas pressure (curve 1), electric consumption power (curve 2) characterized by the voltage applied across the furnace, mass of the drop (curve 3), temperature of the drop (curve 4) and speed of the feeding rod (curve 5).

According to this example, during the initial approximately 14 min, the temperature of the droplet is controlled for maintaining it at a desired constant value close to 1180° C. by the corresponding adjustment of the negative gas pressure in the glass tubing and electric consumption power. It can be seen that in the beginning of the process, the speed of the feeding rod has been approximately 6 mm per min and the mass of the drop has been approximately 15.5 gram. The linear speed of the microwire drawn from the drop has been approximately 140 m per min. The mass of the drop decreases during the manufacturing process over the initial 14 min to the value of approximately 15 grams. Such decrease of the mass is associated with a high value of consumption of the rod material due to the relatively high value (with respect to the corresponding speed of the rod) of the linear speed of the microwire drawn from the drop.

In order to avoid a decrease in the temperature (due to the decrease of the mass and correspondingly the heating efficiency of the drop) over the initial 14 min, the controller of the system generates a furnace power signal for increasing the electric power supplied to the furnace. As a result, the voltage supplied to the furnace increases from the value of approximately 325 volt to the value of approximately 360 volt. At the same time period, in order to avoid the elevation of the drop, the controller of the system generates a vacuum device signal for decreasing the negative gas pressure from the value of approximately −6.1 milibar to approximately −4.9 milibar. The increase of the electric power and decrease of the negative pressure continues up to the time required for the system to recognize that the electric power and the negative gas pressure are not constant As can be seen in FIG. 3, this time is about 14 min. As soon as such time behavior of the electric power and the pressure is detected, the controller generates a corresponding rod feeder signal for increasing the speed of the feeding rod to a value required for stabilizing the consumption of the drop and maintaining the electric consumption power and gas pressure at substantially constant magnitudes during continuation of the microwire production process. According to the example shown in FIG. 3, this value of the speed of the feeding rod is about 6.5 mm per min.

It should be appreciated that although an adjustment of the values of the speed of the feeding rod from 6 mm/min to 6.5 mm/min in the example shown in FIG. 3 has been performed only once (at the time of approximately 14 min, after the beginning of the process), when required in practice, such adjustment can be done in two or more steps.

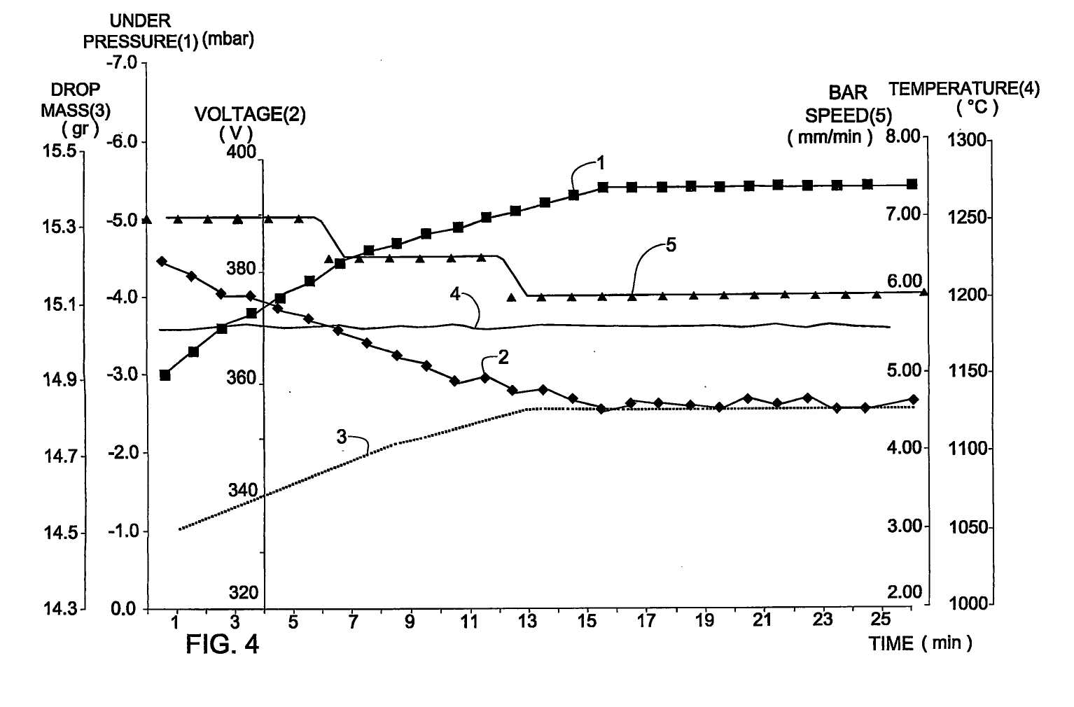

Referring to FIG. 4, another example of regulation of the process parameters during the production of the microwire of the previous example.

In particular, FIG. 4 shows time dependencies of negative gas pressure (curve 1), electric consumption power (curve 2) characterized by the voltage applied across the furnace, mass of the drop (curve 3), temperature of the drop (curve 4) and speed of the feeding rod (curve 5).

According to this example, during the initial approximately 6 min, the temperature of the droplet is controlled for maintaining at a desired constant value close to 1180° C. by the corresponding adjustment of the negative gas pressure in the glass tubing and electric consumption power. It can be seen that in the beginning of the process, the speed of the feeding rod was approximately 7 mm per min and the mass of the drop was approximately 14.1 gram. The linear speed of the microwire drawn from the drop is approximately 140 m per min. The mass of the drop increases during the manufacturing process over the initial 6 min to the value of approximately 14.8 grams. Such increase of the mass is associated with a low value of consumption of the rod material due to the relatively low value (with respect to the corresponding speed of the rod) of the linear speed of the microwire drawn from the drop.

In order to avoid an increase in the temperature (due to the increase of the mass and correspondingly the heating efficiency of the drop), the controller of the system generates a furnace power signal for decreasing the electric power supplied to the furnace. As a result, the voltage supplied to the furnace decreases over the initial 6 min. from the value of approximately 380 volt to the value of approximately 370 volt. At the same time period, in order to elevate the drop, the controller of the system generates a vacuum device signal for increasing the negative gas pressure from the value of approximately −3.1 milibar to approximately ˜4.3 milibar.

The decrease of the electric power and increase of the negative gas pressure continues up to the time required for the system to recognize that the electric power and the negative gas pressure are not constant (according to the example shown in FIG. 4, this time is about 6 min). As soon as such time behavior of the electric power and the negative pressure is detected, the controller generates one or more corresponding rod feeder signals for decreasing the speed of the feeding rod to a value required for stabilizing the mass of the drop and maintaining the electric consumption power and gas pressure at substantially constant values during continuation of the microwire production process.

According to the example shown in FIG. 4, the decrease of the speed of the feeding rod has been performed in two steps. Thus, the first decrease from about 7 mm per min to about 6.5 mm per min slowed down the increase of the drop mass, and respectively changed the rate of the time behavior of the electric power and the negative pressure, however, it did not stabilize the production process. Therefore, after the time of approximately 12 min, the controller generates a second rod feeder signal for the additional decrease of the speed of the feeding rod from the magnitude of approximately 6.5 min per min to approximately 6 min per min. As can be seen in FIG. 4, this operation stabilizes the mass of the drop and leads to maintaining the electric consumption power and gas pressure at substantially constant values during continuation of the microwire production process.

It should be appreciated that a relationship can be established between the linear speed v of the produced microwire and the speed V of the feeding rod. Due to the mass conservation principle, such relationship can be approximated by the following equation:
v=(D/d)²V, (1)
where d and D are the diameter of the metallic part of the microwire and the cylindrical rod, respectively. For example, it can be estimated by using Eq. (1) that for the microwire having the diameter of 33 microns (d=33·10⁻⁶ m) and the cylindrical rod having the diameter of 5 millimeters (D=5·10⁻³ m) and the speed of 6 mm/min (V=6·10⁻³ m/min) the linear speed of the microwire is 138 m/min.

The following properties of the microwires can be obtained by the process and apparatus of the present invention:

The overall diameter can be less than 5 microns.

The overall diameter is relatively uniform and deviation can be less than 2 microns.

The microwire length is practically unlimited.

The metallic core diameter is quite stable and deviation can be less than 10%.

The dielectric strength of the glass insulation is high with the breakdown voltage higher than 20 kV for 2.5 microns glass layer.

The microwire can operate and maintain its insulating properties up to the temperature range of 500° C.-700° C.

The minimal bending diameter can be between 40 to 200 times the diameter of the microwire.

Examples of utilization of the microwires obtained by the method and apparatus of the present invention are multifold. Practical usage of the above advantages includes, but is not limited to, micro cables for telecommunications and miniature high-voltage transformers. Thin sub-ten micron silver or gold microwires can be used as conductors operating at high frequencies.

The microwires based on amorphous metallic alloys may have unique magnetic properties. These materials can successfully replace conventional soft-magnetic materials. The process and apparatus of the present invention enables the fabrication of amorphous materials in the form of wires with thickness ranging between 2 and 150 microns (depending on the application).

Amorphous glass coated microwires obtained by the process and apparatus of the present invention reveal unique mechanical, electrical and magnetic properties. In particular, amorphous microwires based on cobalt, nickel and iron expose extremely high magnetic properties in which they perform better than ferrites and amorphous ribbons which makes them material for high frequency applications in the range from tens of MHz to about several GHz.

The experimental studies carried out by the inventors demonstrate that amorphous glass coated microwires are advantageous for the fabrication of miniature inductive components in comparison with ferrites, amorphous ribbons, or thin magnetic films. It allows extending the operation frequency range and reducing magnetic and proximity losses. Microwire-based magnetic components can be readily integrated into the micro-fabrication technology.

The glass coated amorphous microwires obtained by the process and apparatus of the present invention are promising materials for shielding and noise suppression in the 0.1-2 GHz frequency range. It is known that the effective absorption of the electromagnetic field can be achieved if the magnetic material has a proper value and orientation of the magnetic anisotropy relative to the vectors of the electromagnetic field. It has been found out by the inventors that magnetic anisotropy of the microwire may be strictly controlled during the preparation process. Hence, depending on the composition of the alloy and the diameter of microwire, the field of the internal magnetic anisotropy can lay in the relatively wide range, between 10 and 5000 A/m. It is also possible to produce a microwire magnetized both along and perpendicular to its axis. Moreover, by using composite materials with different orientation of microwire fibers, it is possible to control the space distribution of the magnetic anisotropy of these materials.

Another example of applications of the magnetic microwires obtained by the process and apparatus of the present invention includes, but is not limited to, products for authentication documents, brand protection, and access control. For instance, such microwires can be embedded into security papers (e.g., authentication documents). The magnetic microwires can be used in information-carrying magnetic tags (e.g., magnetic strips and printed magnetic barcodes) utilized for the identification of products and security purposes.

As such, those skilled in the art to which the present invention pertains, can appreciate that while the present invention has been described in terms of preferred embodiments, the concept upon which this disclosure is based may readily be utilized as a basis for the designing of other structures, systems and processes for carrying out the several purposes of the present invention.

It is apparent that although the configuration of the system for the controllable production of a microwire were shown for providing continuous lengths of microwire having a uniform diameter, the process of the present invention can be applied for providing a microwire having any other stable technical characteristic, e.g. a running resistance, strength, etc.

It should be apparent that the manufacturing process and article manufactured thereby in accordance with the present invention may be equally well-suited for use in the manufacture of a wide variety of coated wire composites and is not necessarily limited to the manufacture of the particular examples described herein.

Moreover, any reference to a specific implementation in terms of usage of the glass and rod feeder mechanisms, the furnace, the vacuum device, the receiver section, the control module, or any other components are shown by way of a non-limiting example. When required, the system for controllable production of continuous lengths of microwire of the invention may include also other modules. For example, the system can include a camera for measuring the size of the drop in the tubing and the position of the drop relatively to the induction coil. The camera can produce a drop size sensor signal and be operatively coupled to the controller (109 in FIG. 1) that should be responsive to the drop size sensor signal and operable for generating a corresponding signal to the rod feeder mechanism (103 in FIG. 1) for the adjustment of the supply of the core material.

It should be appreciated that the controller 109 can be configured either in one controller device that can serve a multiple function for controlling the system 10 or as a number of units, each performing a corresponding specific function.

In the process claims that follow, alphabetic characters used to designate claim steps are provided for convenience only and do not imply any particular order of performing the steps.

Also, it is to be understood that the phraseology and terminology employed herein are for the purpose of description and should not be regarded as limiting.

It is important, therefore, that the scope of the invention is not construed as being limited by the illustrative embodiments and examples set forth herein. Other variations are possible within the scope of the present invention as defined in the appended claims and their equivalents.

1. A process for controllable production of continuous lengths of microwire having a core covered by a glass coating, comprising:
(a) providing a glass tubing;
(b) loading the glass tubing with a core material;
(c) heating the tubing containing the core material, thereby melting said core material, softening a tip of said glass tubing and forming a drop of the core material in the molten state surrounded by an outer glass shell;
(d) evacuating gas from said glass tubing to control elevation of the drop;
(e) drawing the heated outer glass shell into a continuous microwire filament; and
(f) stabilizing the temperature and mass of the drop during the process.

2. The process of claim 1 wherein stabilizing the temperature and mass of the drop is performed by controlling the negative gas pressure in the tubing and the electric power consumption.

3. The process of claim 2 wherein controlling the negative gas pressure in the tubing and the electric power consumption is performed by adjusting the speed of supply of the core material.

4. The process of claim 3 wherein adjusting the speed of supply of the core material is performed until the negative gas pressure in the tubing and the electric power consumption are stabilized to substantially constant magnitudes.

5. The process of claim 1 wherein stabilizing the temperature and mass of the drop is performed by adjusting the speed of said continuous microwire filament.

6. The process of claim 5 wherein the speed of the filament is in the range of about 5 m/min to 1500 m/min.

7. The process of claim 1 wherein said temperature of the drop is in the range of about 800° C. to 1500° C.

8. The process of claim 1 wherein the material of said glass tubing is selected from silica glasses, alkali silicate glasses, soda-lime glasses, borosilicate glasses, aluminosilicate glasses and lead glasses.

9. The process of claim 1 wherein said core material is selected from conducting material, elemental semiconductor, metalic superconductor and semiconducting compound having a melting temperature below the working temperature of the material of said glass tubing.

10. The process of claim 9 wherein said conducting material is a metal selected from copper, gold, silver, platinum, rhodium, iron, nickel, and alloys based on these metals.

11. The process of claim 9 wherein said conducting material is a metal or metal alloy having a melting point in the range 800° C. to 1800° C.

12. The process of claim 9 wherein said nonceramic semiconducting compound is selected from GaSb and InSb.

13. The process of claim 1 further comprising cooling said continuous microwire filament.

14. The process of claim 13 wherein the rate of cooling is in the range of about 10⁵° C./sec to 10⁶° C./sec.

15. The process of claim 13 further comprising applying a tension to the microwire obtained from said microwire filament.

16. The process of claim 15 including waxing said microwire.

17. The process of claim 16 further comprising collecting said microwire by a receiving spool rotating at a controllable cyclic speed.

18. The process of claim 1 wherein said heating is performed inductively by means of a radiant high frequency induction coil.

19. The process of claim 1 wherein said heating is carried out resistively by a crucible made of electrically conductive material.

20. The process of claim 1 wherein said glass tubing is evacuated to a pressure varied in the range of about 0 milibars to −30 milibars.

21. The process of claim 9 wherein said core material is in the form of a cylindrical rod.

22. The process of claim 21 wherein a diameter of said cylindrical rod is in the range of about 0.1 to 4 mm for conducting materials, and in the range of about 2 to 7 mm for nonconductive and semiconductive materials.

23. The process of claim 8 wherein a diameter of the glass tuning is in the range of about 8 mm to 30 mm.

24. A system for controllable production of continuous lengths of a microwire having a core covered by a glass coating, comprising:
(a) a glass feeder mechanism controllable by a glass feeder signal for providing a supply of a glass tubing;
(b) a rod feeder mechanism controllable by a rod feeder signal for providing a supply of a rod made of a core material;
(c) a furnace configured for forming a drop of the core material in the molten state surrounded by an outer glass shell;
(d) a vacuum device controllable by a vacuum device signal for providing variable negative pressure in the tubing to the molten drop in the region of contact with the glass;
(e) a cooling device downstream of the furnace adapted for cooling the microwire drawn out from the drop;
(f) a receiver section downstream of said cooling device including:
a spooler having at least one receiving spool and a drive motor assembly controllable by a spool speed signal, the spooler being adapted for receiving the microwire obtained after the cooling;
(g) sensing means configured for producing at least one sensor signal from the list including:
a pressure sensor signal representative of the gas pressure in the tubing,
a temperature sensor signal representative of the temperature of the drop,
a wire speed sensor signal representative of the speed of the microwire,
a diameter sensor signal representative of the value of the microwire diameter,
a spool diameter sensor signal representative of the value of the spool diameter;
(h) a controller operatively coupled to said glass feeder mechanism, said rod feeder mechanism, said furnace, said controllable receiver unit and said sensing means,
said controller being responsive to said at least one sensor signal and configured for controlling the operation of the system by generating at least one signal selected from the list including: said glass feeder signal, said rod feeder signal, said furnace power signal, the vacuum device signal, the spool speed signal and a wire tension signal.

25. The system of claim 24 wherein said furnace includes a high frequency induction coil.

26. The system of claim 24 further including:
(i) a tension unit having a tension sensor operable for producing a tension sensor signal and a tension generator controllable by said wire tension signal, the tension unit is arranged for creating tension of the microwire.

27. The system of claim 24 further including:
(j) a wax applicator adapted for waxing the microwire;

28. The system of claim 24 wherein said sensing means includes:
(A) a pressure sensor coupled to the vacuum device and operable for producing said pressure sensor signal;
(B) a temperature sensor coupled to said furnace and operable for producing said temperature sensor signal;
(C) a micrometer operatively coupled to the controller and operable for measuring at least one of the following: the diameter, length and speed of the microwire;

29. The system of claim 24 wherein said vacuum device includes:
(A) a first vessel containing a gas;
(B) a second vessel containing the gas;
(C) a pump configured for transferring the gas from said first vessel to said second vessel through a pipeline, thereby maintaining a negative gas pressure in said second vessel;
wherein said first vessel being communicating with said second vessel through a first valve and with said glass tubing through a second valve, said first valve and said second valve being controllable by said controller for providing variable negative gas pressure to the tubing.

30. The system of claim 29 wherein said negative gas pressure in said second vessel is in the range of about −100 milibars to −400 milibars.

31. The system of claim 29 wherein said gas is selected from air, argon, and nitrogen or a mixture thereof.

32. The system of claim 24 wherein said vacuum device operates on the Venturi affect.

33. The system of claim 24 wherein the material of said glass tubing is selected from silica glasses, alkali silicate glasses, soda-lime glasses, borosilicate glasses, aluminosilicate glasses and lead glasses.

34. The system of claim 24 wherein said core material is selected from conducting material, elemental semiconductor, nonceramic semiconducting compound and metallic superconducting having a melting temperature below a working temperature of the material of said glass tubing.

35. The system of claim 34 wherein said conducting material is a metal selected from copper, gold, silver, platinum, rhodium, iron, nickel, and alloys based on these metals.

36. The system of claim 34 wherein said nonceramic semiconducting compound is selected from GaSb and InSb.

37. The system of claim 29 wherein the negative gas pressure in said glass tubing is varied in the range of about −0 milibars to −30 milibars.

38. The system of claim 24 wherein said rod has a cylindrical form.

39. The system of claim 38 wherein the diameter of the rod is in the range of about 0.1 to 4 mm for heat conducting materials and in the range of about 2 to 7 mm for low heat conductive materials.

40. The system of claim 24 wherein the diameter of the glass tuning is in the range of about 8 mm to 30 mm.
